(19) United States
(12) Patent Application Publication
(10) Pub. No.: US 2023/0068317 A1
(43) Pub. Date: Mar. 2, 2023

(54) WiFi Enabled Barcode Scanner With Customizable Key/Value Pairs and Switch for Sending HTTP POST Requests

(71) Applicants: Mathew Ranha, Westerville, OH (US); John Whalen, Columbus, OH (US)

(72) Inventors: Mathew Ranha, Westerville, OH (US); John Whalen, Columbus, OH (US)

(21) Appl. No.: 17/465,771

(22) Filed: Sep. 2, 2021

(51) Int. Cl. G06K 7/10; H04L 29/08

(52) U.S. Cl. CPC G06K 7/10881; H04L 67/02

(57) ABSTRACT

In inventory management barcodes scanners are a very useful tool. Most barcode scanners are tethered via a USB cable, or must be relatively close to a host computer using wire-less communication protocols. This invention is enables a barcode scanner unit to be able to connect to Wi-Fi and send data immediately to any host server in the world. Customizable HTTP POST requests let end customers choose any extra data, such as locations and user identification, to send with each barcode that has been scanned. Switches on the unit can be activated to change the POST requests being sent without having to reprogram the unit. The small footprint of the device allows it to be integrated easily into handheld scanners, existing cabinetry, assembly lines, and appliances.

### CROSS-REFERENCE TO RELATED APPLICATIONS

TBD

### BACKGROUND OF THE INVENTION

There are many types of barcode scanners on the market today that send data through a wire or via BlueTooth technology. These scanners require a local host computer in order to send data to a server over the internet. The need for a local computer to process incoming data from a barcode scanner can be eliminated by equipping the barcode scanner with an Internet-of-Things device. This allows the barcode scanner to, be a wifi-enabled barcode scanner, connected to a local wi-fi network, send the scanned data to any server in the world.

### BRIEF SUMMARY OF THE INVENTION

The barcode scanner can be programmed with a host server's URL and HTTP POST requests can be sent with customizable key/value pairs. These key value pairs can let the host server know more information about the scan that took place. Such as the location of the scanner, the location within a location, a user identification, or other information a developer may want to include. The wifi-enabled barcode scanner also has a single-pole double-throw switch that will send the state of the switch as a key/value pair in each POST request. This is helpful in the fact that simply switching the switch off or on will change the parameter in the HTTP POST Request to let the host server know whether an item was scanned into or out of inventory.

### BRIEF DESCRIPTION OF THE SEVERAL VIEWS OF THE DRAWING

The design can be broken down into 2 sections. The first part consists of the hardware which is shown in FIG. 1. A USB Power supply (1) capable of providing 5 volt DC voltage and up to 1 Amp of current. There is also the option of powering the device with a 3.7V lithium Ion re-chargable battery and a charging integrated circuit that is powered by any USB charing device. The power supply will supply 5 volts of DC voltage and a ground return (2) to the barcode scanner (5), the rocker switch (3) and the Internet-of-Things integrated circuit (4). A 1-D laser bar code scanner (5) with serial UART output (7) is connected to the Internet-of-Things integrated circuit (4) UART. A single pole double throw type rocker switch (3) has its output (6) connected to an Input/Output pin of the Internet-of-Things integrated circuit (4). The Internet-of-Things integrated circuit waits to receive scanned data from the barcode scanner (5). Once data is received an HTTP POST request is generated with the scanned data (7), the switch (3) state (6) and any key/value pairs programmed by the user. The HTTP POST request data (8) is then sent from the Internet-of-Things integrated circuit (4) via the user programmed local wi-fi network (9) to the user programmed Host Server (10).

The second part is the software used to program the IoT module, which allows the customization of the host servers URL and key/value Paris used to send a POST request whenever a bar code has been scanned. When setting up the WiFi scanner the parameters used for the POST request are static. By default there is one parameter for the POST request that is set and is based on the state of the switch (3).

FIG. 2 shows the software flowchart for the code that is programmed into the Internet-of-Things integrated circuit (4). When the bar code scanner is first turned on the Internet-of-Things integrated circuit (4) tries to connect to the WiFi network that is saved in its memory. If the Internet-of-Things integrated circuit (4) can not connect for any reason, it will set itself up as a Wi-Fi access point. The user can then use any user device equipped with WiFi and a web browser to connect to the scanners newly created Wi-Fi Access Point. Once connected, the user device will open a web browser and will load the HTML connection screen. This connection screen is written in HTML and programmed into the Internet-of-Things integrated circuit (4), and contains all the user input fields needed to select an available WiFi network, enter a WiFi password, set the Host Servers URL and set the customized parameter names and values for sending POST requests. Each parameter can have a custom name and value programmed into memory, that will be sent with each bar code that is scanned. Once all necessary fields are populated and the user clicks the connect button the Internet-of-Things integrated circuit (4) will reboot and attempt to connected to the WiFi network specified. If a WiFi connection could not be established the Internet-of-Things integrated circuit (4) will go back in to Access Point mode where a user can re-enter the correct information.

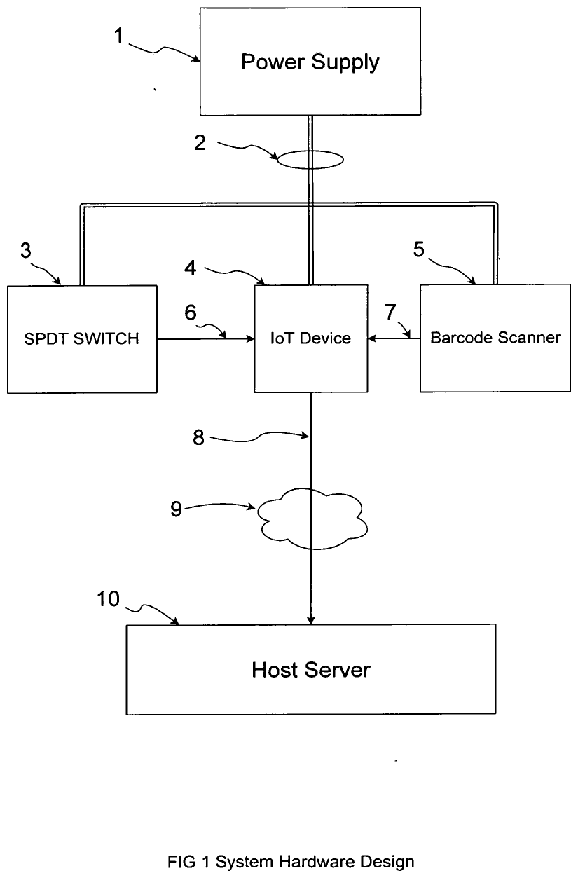

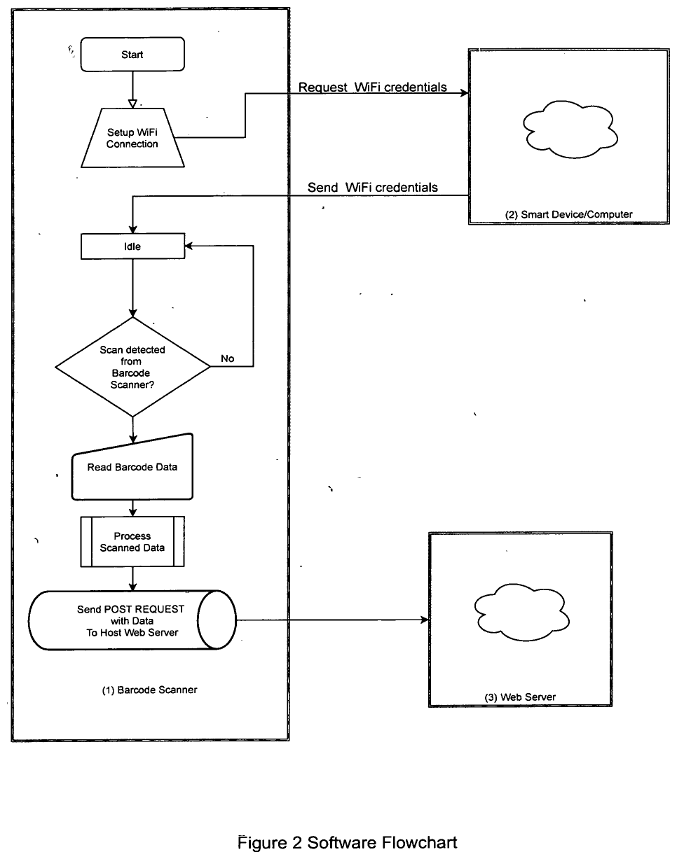

After a successful connection to a WiFi network the Internet-of-Things integrated circuit (4) waits for a scan event to occur. Once a scan has completed the Internet-of-Things integrated circuit (4) will check the state of the SPDT switch (3) to determine the proper parameter value to send in the POST request. The scanned barcode data, switch state, and parameter key/value pairs are then sent to the host server URL via a POST REQUEST. Then the scanner goes into its idle state as it waits for the next scan.

A case example would be inventory management in a warehouse. Since the scanner is connected to the WiFi it does not have to be tethered to a computer via a USB cable, and its range is much greater than using BlueTooth. The device is setup with the URL of the host server to send the scanned data. The custom parameters are set up to specify the specific location of the warehouse, and another parameter is used to setup the location within the warehouse. This will allow a central host server to handled the POST requests from many different locations. The state of the switch is used to determine if a scanned item is to be added to stock or removed from stock.

1. A WiFi enabled barcode scanner.

2. Customizable key/value pairs when sending HTTP POST Requests.

3. Rocker switch for quickly changing a key/value pair while scanning.
